(19) United States
(12) Patent Application Publication
(10) Pub. No.: US 2008/0309582 A1
(43) Pub. Date: Dec. 18, 2008

(54) RECEIVING ASSEMBLY WITH FUNCTION OF DISPLAYING DATA ABOUT OBJECTS THEREIN

(76) Inventor: Chih-Ching Hsieh, Taichung City (TW)

Correspondence Address: CHIH-CHING HSIEH, 235 Chung-Ho Box 8-24, Taipei, 235, TW

(21) Appl. No.: 11/762,070

(22) Filed: Jun. 13, 2007

(51) Int. Cl. G09G 5/00

(52) U.S. Cl. 345/1.3

(57) ABSTRACT

A receiving assembly with a function of displaying data about objects therein, comprises: a container having at least one receiving unit; at least one sensor unit being installed in the receiving unit for sensing data about objects in the receiving unit and transferring the data; a display unit for receiving data from the at least one sensor unit and displaying the data on a screen of the display unit; the display unit being installed at an exterior of the container; and an operating unit for adjusting display ways of the display unit; and by the display unit to display data from the sensor unit; the object in the receiving unit can be known. The operating unit serves to divide the screen of the display unit into one frame or a plurality of sub-frames.

### FIELD OF THE INVENTION

The present invention relates to toolboxes, and particularly to a receiving assembly with a function of displaying data about objects therein so that the user can know the information about the tool in the toolbox without needing to open the toolbox.

### BACKGROUND OF THE INVENTION

Currently more and more tools are used in working or daily life. Thus tool boxes are developed for locating the tools. However because there are many tools being used and thus they are located in the box. As too many different kinds of tools are placed in the tool box, they are often not classified or identified. Furthermore, the tools are not located with an order known by the users or according to the indications on the box. As a result, the user can not know the objects in the toolbox, or can not know what tools are placed in the toolbox, even can not know that a tool is placed in which drawer for searching. There are some developments related to toolboxes being disclosed. However all these developments are aimed at the improvement of the mechanical structure of the toolbox, for example installing sliding tracks and elastic units to guide the drawers so that the user can open or close the drawers easily and conveniently, but these improved structures can not resolve above problems about the searching of a tool.

Thus there is an eager demand for a novel design which can improve the prior art defects.

### SUMMARY OF THE INVENTION

Accordingly, the primary object of the present invention is to provide a receiving assembly with a function of displaying data about objects therein so that the user can know the information about the tool in the toolbox without needing to open the toolbox.

To achieve above objects, the present invention provides a receiving assembly with a function of displaying data about objects therein, comprising a container having at least one receiving unit; at least one sensor unit being installed in the receiving unit for sensing data about objects in the receiving unit and transferring the data; a display unit for receiving data from the at least one sensor unit and display the data on a screen of the display unit; the display unit being installed at an exterior of the container; and an operating unit for adjusting display ways of the display unit; and by the display unit to display data from the sensor unit; the object in the receiving unit can be known. The operating unit serves to divide the screen of the display unit into one frame or a plurality of sub-frames.

The various objects and advantages of the present invention will be more readily understood from the following detailed description when read in conjunction with the appended drawing.

### BRIEF DESCRIPTION OF THE DRAWINGS

FIG. 1 is a perspective view showing the structure of the present invention.

FIG. 2 is a perspective view of the present invention, wherein the contents of the receiving assembly of the present invention is illustrated.

FIG. 3 is a schematic view showing that the display unit has only one frame.

FIG. 4 is a schematic view showing that the display unit has four sub-frames.

FIG. 5 is a perspective view showing that the container of the present invention has eight receiving units and the display unit has eight sub-frames.

FIG. 6 is a perspective view showing that the display unit of the present invention is foldable.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

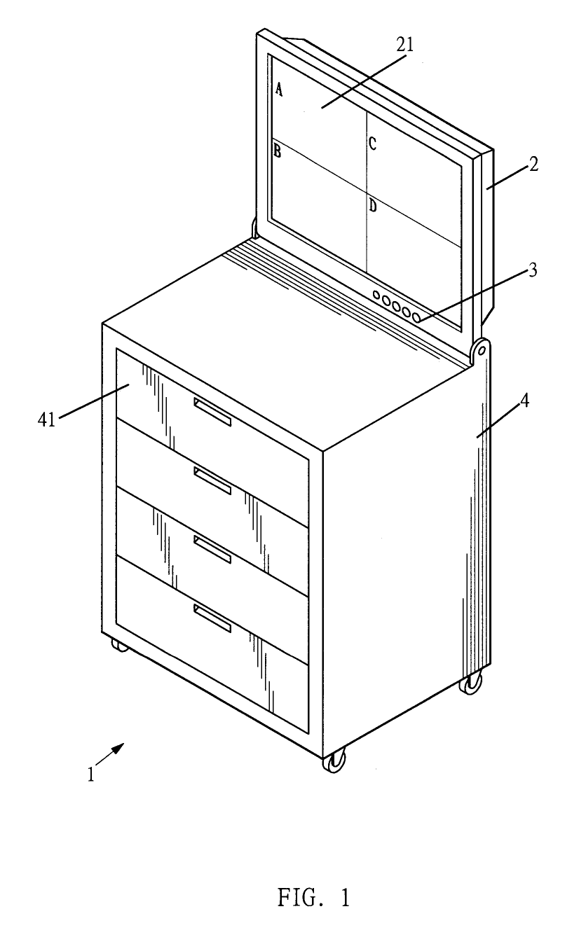

Referring to FIG. 1, the receiving assembly 1 with a function of displaying contents therein. The present invention has the following elements.

A container 4 has a plurality of receiving units 41 for receiving and storing objects. The receiving units 41 can be opened or closed freely. In this embodiment, the receiving units 41 are drawers.

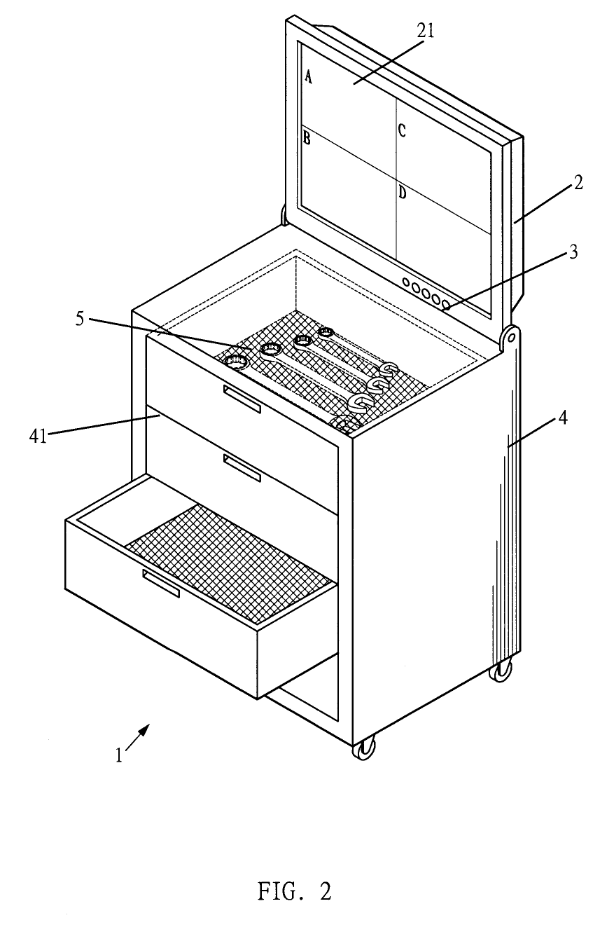

At least one sensor unit 5 is included. In this embodiment, each receiving unit 41 has a sensor unit 5 (referring to FIG. 2) for sensing objects in the receiving unit 41. However in the present invention, maybe some receiving units 41 have no sensor unit 5 or one receiving unit 41 has more than one sensor unit 5. All these are within the scope of the present invention. The sensor unit 5 is installed at a bottom surface of the receiving units 41. The sensor unit 5 has a plate like structure. The objects in the receiving unit 41 are placed upon the sensor unit 5. The sensor unit 5 senses data (such as the pressure, volume, area, weight, etc.) of the object and then transfers the sensing result.

A display unit 2 is for example a liquid crystal display, an LED display, a cathode ray display, a plasma display, etc. The display unit 2 receives data from the sensor unit 5 and then displays the data about the pressure, volume, area, weight, etc., of the object.

An operating unit 3 is installed near the display unit 2. The operating unit 3 serves to control and adjust the display unit 2. The user changes the displaying way by controlling and adjusting the display unit 2. The frame of the display unit 2 can be divided into a plurality of sub-frames 21 or a single frame 21.

Thus, in use, the receiving assembly 1 of the present invention can display the contents in the container 4. The user can operate the operating unit 3 so as to divide the frame of the display unit 2 into one frame 21 or a plurality of sub-frames 21.

Referring to FIG. 2, in this embodiment, each receiving unit 41 has a respective sensor unit 5 which is installed upon the bottom surface of the receiving unit 41 and has a plate like structure for sensing data about the objects in the receiving unit 41.

The sensor unit 5 may be a pressure sensor, a light sensor or a sound wave sensor, etc.

If the sensor unit 5 is a pressure sensor, the sensor unit 5 is made of various conductive layers at different elevations. By the weight of the object placed thereupon, the conductive layers will conduct. Thus by the voltage variation of the conductive layers, it can detect the volume or weight of the object thereupon. The detected data is then transferred to the display unit 2.

If the sensor unit 5 is a light sensor, when an object is placed upon the sensor unit 5, the sensor unit 5 is full of light receivers, in which the light is shielded by the object, the sensor unit 5 will get the precise form or shape or volume of the object. Then the detected data is transferred to the display unit 2.

If the sensor unit 5 is a sound wave sensor, when an object is placed upon the sensor unit 5, the sensor unit 5 will emit supersonic waves. As the supersonic wave contacts upon the object, it will be absorbed and then decay. Then the reflected supersonic wave is weakened. Thereby the decaying of the reflected wave will be got and the form of the object is detected. The data is transferred to the display unit 2 for displaying.

The operation principles of above mentioned sensor units 5 are known in the prior art.

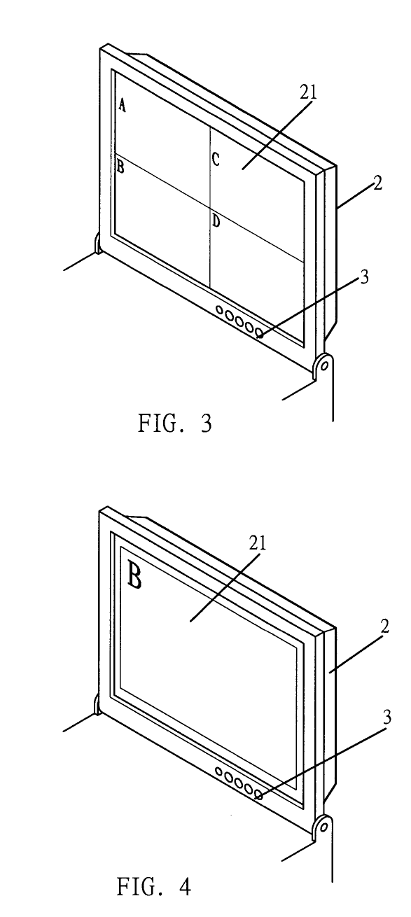

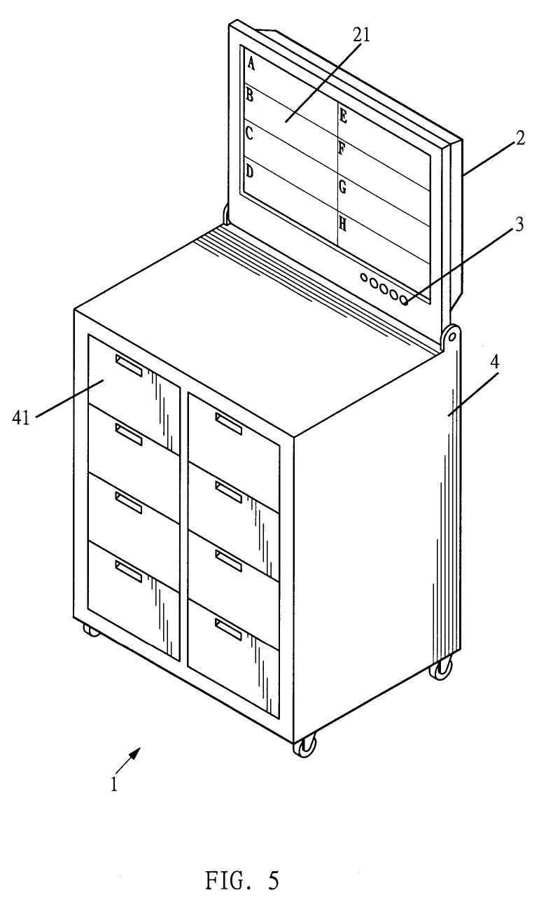

Referring to FIGS. 3 and 4, in FIG. 3, it is illustrated that the frame of the display unit 2 is divided into four sub-frames 21 by adjusting the operating unit 3 or the frame of the spacing 21 has only one frame 21 (see FIG. 4). All these are determined by the requirement of the user.

Referring to FIGS. 5, the second embodiment of the present invention is illustrated. In this embodiment, those identical to the above embodiment will not be further described herein. Only those different from above embodiment are described. In this embodiment, the container 4 has eight receiving units 41 and the frame of the display unit 2 is divided into eight sub-frames 21.

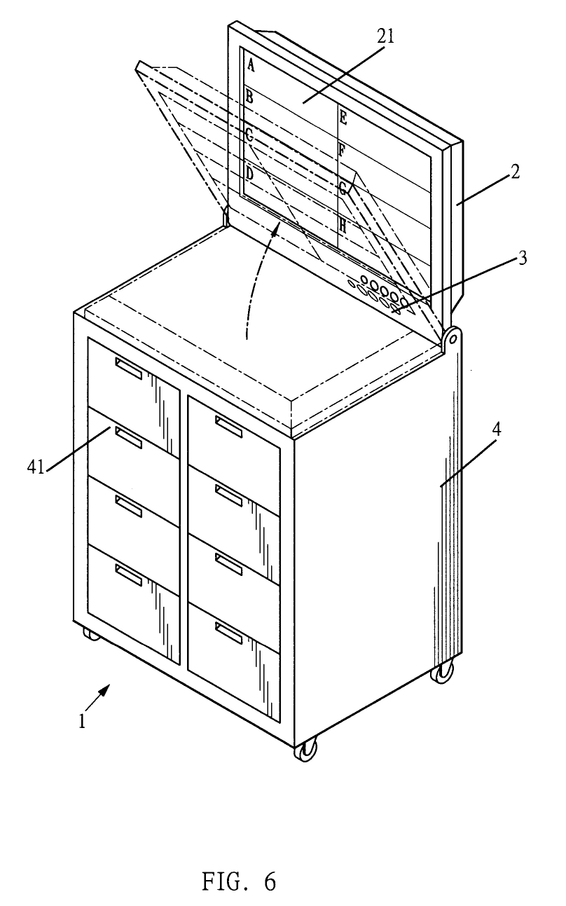

Referring to FIGS. 6, the third embodiment of embodiment is illustrated. In this embodiment, those identical to the above embodiment will not be further described herein. Only those different from above embodiment are described. It is illustrated in FIG. 6 that the display unit 2 is folded for storage and damage-proof. In FIG. 6, it is illustrated that the display unit 2 is folded to be adhered upon an upper surface of the container 4.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A receiving assembly with a function of displaying data about objects therein, comprising:
a container having at least one receiving unit;
at least one sensor unit being installed in the receiving unit for sensing data about objects in the receiving unit and transferring the data;
a display unit for receiving data from the at least one sensor unit and displaying the data on a screen of the display unit; the display unit being installed at an exterior of the container; and
an operating unit for adjusting display ways of the display unit; and
wherein by the display unit to display data from the sensor unit, the object in the receiving unit can be known.

2. The receiving assembly with a function of displaying data about objects therein as claimed in claim 1, wherein the operating unit serves to divide the screen of the display unit into one frame or a plurality of sub-frames.

3. The receiving assembly with a function of displaying data about objects therein as claimed in claim 1, wherein the sensor unit has a plate like structure and is placed upon a bottom surface of the receiving unit.

4. The receiving assembly with a function of displaying data about objects therein as claimed in claim 1, wherein the sensor unit is a pressure sensor, the sensor unit is made of various conductive layers at different elevations; by the weight of the object placed thereupon, the conductive layers will conduct; thus by voltage variation of the conductive layers, it can detect the volume or weight of the object thereupon; and the detected data is then transferred to the display unit.

5. The receiving assembly with a function of displaying data about objects therein as claimed in claim 1, wherein the sensor unit is a light sensor, when an object is placed upon the sensor unit, the sensor unit is full of light receivers, as the light is shielded by the object, the sensor unit will get the precise form or shape or volume of the object; and then the detected data is transferred to the display unit.

6. The receiving assembly with a function of displaying data about objects therein as claimed in claim 1, wherein the sensor unit is a sound wave sensor, when an object is placed upon the sensor unit, the sensor unit will emit supersonic waves; as the supersonic wave contacts upon the object, it will be absorbed or then decay; then the reflected supersonic wave is weakened; thereby the decaying of the reflected wave will be got and the form of the object is detected; and then the data is transferred to the display unit for displaying.

7. The receiving assembly with a function of displaying data about objects therein as claimed in claim 1, wherein the receiving unit is a drawer.

8. The receiving assembly with a function of displaying data about objects therein as claimed in claim 1, wherein the display unit is foldable to be placed upon a surface of the container.
